(19) United States
(12) Patent Application Publication
(10) Pub. No.: US 2004/0088072 A1
(43) Pub. Date: May 6, 2004

(54) Control console of injection-molding machines

(75) Inventor: Takashi Yamazaki, Mishima-shi (JP)

Correspondence Address: PILLSBURY WINTHROP, LLP, P.O. BOX 10500, MCLEAN, VA, 22102, US

(73) Assignee: TOSHIBA MACHINE CO., LTD., Tokyo (JP)

(21) Appl. No.: 10/694,007

(22) Filed: Oct. 28, 2003

(30) Foreign Application Priority Data
Oct. 29, 2002 (JP) 2002-314578

(51) Int. Cl. B29C 45/76

(52) U.S. Cl. 700/200; 425/163; 425/574

(57) ABSTRACT

An object of the present invention is to provide an injection-molding machine capable of accurately and conveniently setting operational conditions in the filling and pressure-holding steps. A curve showing the position of a screw versus time in the filling and pressure-holding steps is displayed on the same screen as that displaying settings for a forward speed and a back-pressure of the screw in the filling and pressure-holding steps. The operator can change settings while monitoring the data indicated by a curve displayed on the screen. Examples of the settings include a screw speed in filling step, pressure in filling step, pressure-switching time in pressure-holding step, screw speed in pressure-holding step, and period of injection

### CROSS-REFERENCE TO RELATED APPLICATIONS

This application is based upon and claims the benefit of priority from the prior Japanese Patent Application No. 2002-314578, filed Oct. 29, 2002, the entire contents of which are incorporated herein by reference.

### BACKGROUND OF THE INVENTION

1. Field of the Invention

The present invention relates to an injection-molding machine, and more particularly, the configuration of a display screen of a control console used in the injection-molding machine.

2. Description of the Related Art

FIG. 6 shows a schematic structure of an injection-molding machine. In the figure, reference numeral 1 represents an injection unit, 2 a clamping unit, 3 dies, 4 a heating barrel, and 5 a screw.

In the injection-molding machine, after a raw-material resin is introduced and melted in the heating barrel 4 (called a “charging step”), the resin is injected from the heating barrel 4 into the dies 3 to fill the dies 3 with the molten resin (called a “filling step”).

In the charging step, the raw material resin is introduced into the heating barrel 4 from a hopper 6 by rotating the screw 5 in the heating barrel 4. The introduced raw material resin, while being heated and kneaded, is moved toward the tip portion of the heating barrel 4. The resultant molten resin is stored in the tip portion. The stored molten resin produces pressure, which moves back the screw 4 in the heating barrel 4. When a predetermined amount of molten resin is stored in the tip portion of the heating barrel 4, the rotation of the screw 5 is stopped, thereby terminating the charging step.

In the filling step, the screw 5 is moved forward in the heating barrel 4 in accordance with a predetermined pattern of speed or pressure conditions to supply the molten resin from the heating barrel 4 into the dies 3 through a nozzle. After the cavity between the dies 3 is filled with the molten resin, the operation goes to a pressure-holding step.

In the pressure-holding step, a predetermined back-pressure is applied to the screw 5 for a predetermined time. In this manner, the molten resin is replenished to the dies 3 to compensate the amount reduced by solidification.

In a conventional injection-molding machine, two discrete display screens are used for setting operation conditions in the filling and pressure-holding steps. One is a setting screen through which various settings are input. The other is a monitoring screen, on which a curve showing, for example, the position of the screw versus time is indicated for monitoring. The operator can confirm the operation state of the step just completed by monitoring the curve displayed on the monitoring screen. After the operator carefully analyzes as to whether the operation conditions are proper or not or whether settings are better to change or not in order to reduce the cycle time, if necessary, the monitoring screen is switched to the setting screen to change the settings.

When the operator changes a number of items, switching from the monitoring screen to the setting screen, and vice versa, must be repeated a plurality of times. Thus, the low workability becomes a problem.

### BRIEF SUMMARY OF THE INVENTION

The present invention has been attained in view of the operational problems with conventional injection-molding machines. An object of the present invention is to provide an injection-molding machine capable of setting operational conditions conveniently and accurately in the charging and pressure-holding steps.

According to the present invention, there is provided a control console of an injection-molding machine comprising:

a first region displaying a curve showing a position of a screw versus time in filling and pressure-holding steps, and

a second region displaying settings for specifying a forward speed and back-pressure of the screw in the filling and pressure-holding steps,

in which the first and second regions are arranged on the same display screen such that the settings can be changed while monitoring the curve.

The settings include a screw speed in filling step, pressure in filling step, pressure-switching time in pressure-holding step, screw speed in pressure-holding step, and period of injection. Note that the screw speed in filling step refers to the forward speed of the screw in the first half of the filling step. The pressure in filling step refers to the back-pressure of the screw in the second half of the filling step. The pressure-switching time in pressure-holding step refers to a time point at which the setting of the back-pressure of the screw in the pressure-holding step is changed. The pressure-switching time is measured from the initiation of the pressure-holding step. The screw speed in pressure-holding step refers to the forward speed of a screw in the pressure-holding step. The period of injection refers to the sum of time of the filling step and the pressure-holding step.

According to the injection-molding machine of the present invention, the operator can change various settings specifying operational conditions while monitoring the data indicated by a curve showing operation state. Since the workability of setting the operational conditions is improved in this way, the setting operation can be easily and accurately performed.

As the curve to be monitored, the position of the screw versus time, the forward speed of the screw versus time, the back-pressure of the screw versus time, the forward speed of the screw versus the position of the screw, and the back-pressure of the screw versus the position of the screw may be displayed.

In addition to the settings described above, the settings may preferably include the position of the screw at which filling pressure is changed, the position of the screw at which the screw speed is changed in the filling step, the time point at which the screw speed is changed in the pressure-holding step (measured from the initiation of the step), the moving-back distance of the screw in the charging step, and pressure settings in the pressure-holding step.

### BRIEF DESCRIPTION OF THE SEVERAL VIEWS OF THE DRAWING

FIG. 1 shows a display screen of the control console used in the injection-molding machine of the present invention;

FIG. 2 shows another display screen of the control console used in the injection-molding machine of the present invention;

FIG. 3 shows another display screen of the control console used in the injection-molding machine of the present invention;

FIG. 4 shows another display screen of the control console used in the injection-molding machine of the present invention;

FIG. 5 shows another display screen of the control console used in the injection-molding machine of the present invention; and

FIG. 6 is a schematic structure of an injection-molding machine.

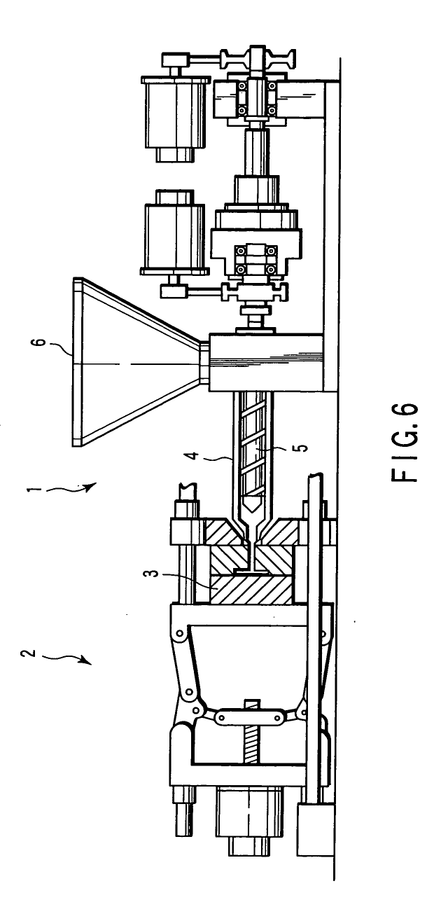

### DETAILED DESCRIPTION OF THE INVENTION

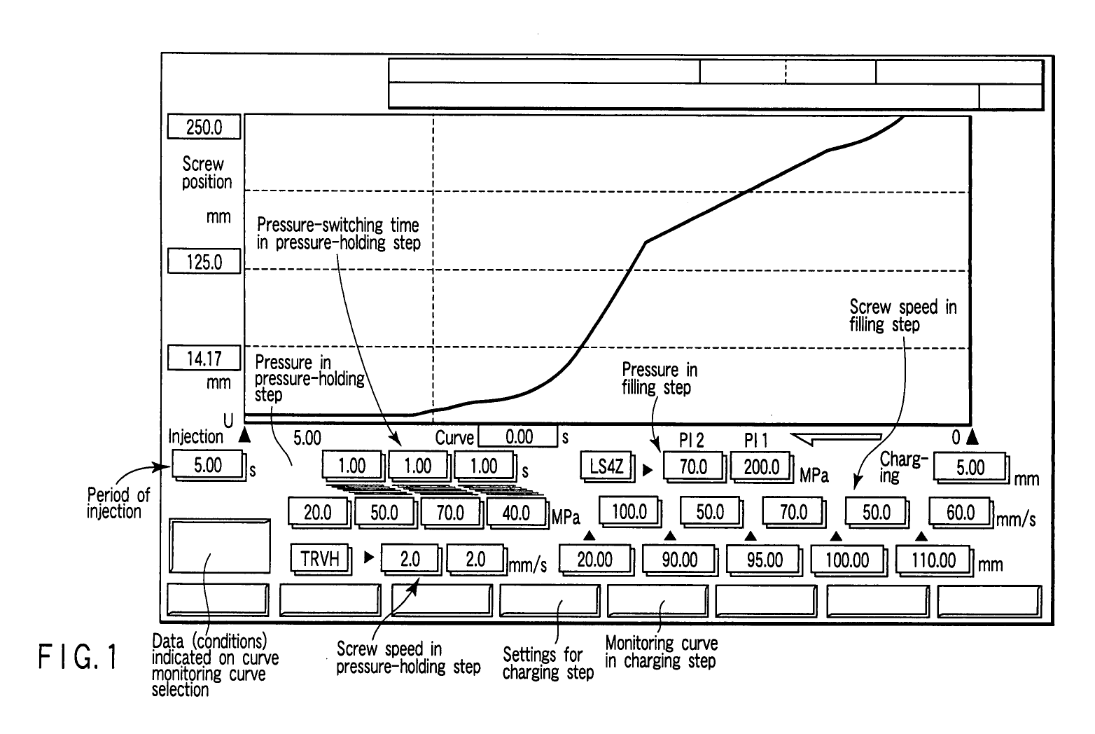

FIG. 1 shows a display screen of the control console used in the injection-molding machine according to the present invention. The display screen is used for setting operational conditions in the filling and pressure-holding steps.

In the upper stage of the display screen, a curve is displayed, which shows the position of the screw versus time in the filling and pressure-holding steps. In the lower stage of the display screen, various settings are displayed for specifying a screw speed in filling step, pressure in filling step, pressure-switching time in pressure-holding step, screw speed in pressure-holding step, and period of injection.

In the case shown in FIG. 1, five settings are provided to change the screw speed in filing step depending upon the position of the screw. Two settings are provided to change the pressure in filling step after the screw reaches a control mode switching position (LS4Z). Three settings are provided to change the pressure with time after the screw reaches a pressure-holding initiation position. Two settings are provided to change the screw speed with time after the screw reaches the pressure-holding initiation position.

An operator analyses as to whether the operational condition now on set is proper or not while monitoring the curve shown on the display screen. If the set value is not proper, the set value is changed on the same display screen.

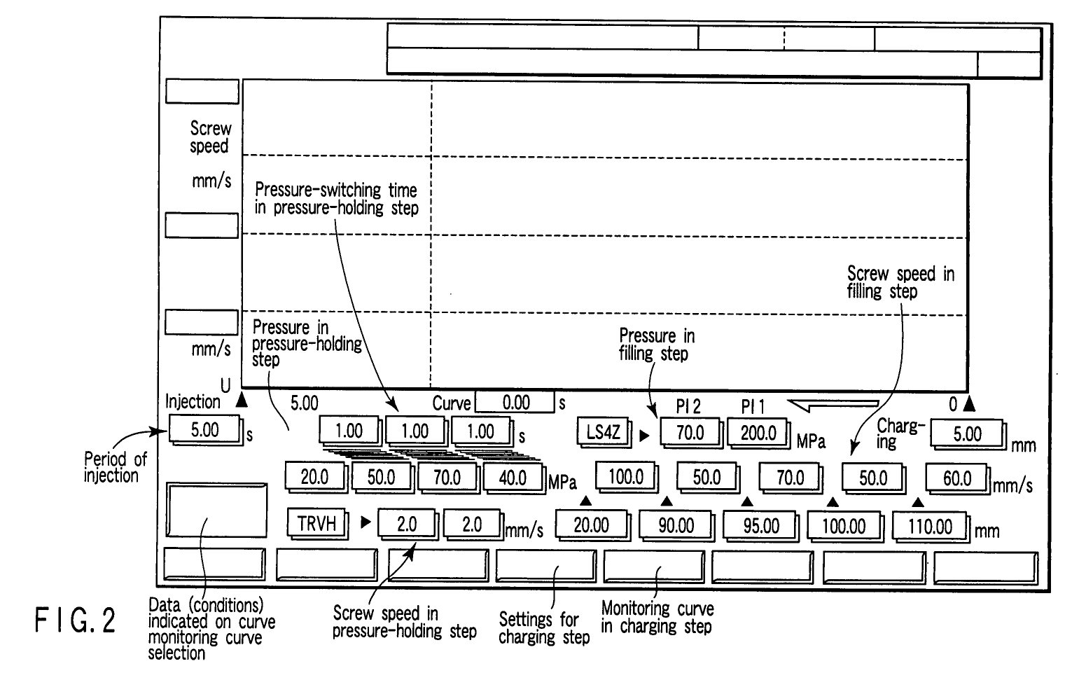

FIG. 2 shows another display screen of the control console used in the injection-molding machine of the present invention. In the upper stage of the display screen, a curve showing the forward speed of the screw versus time is displayed.

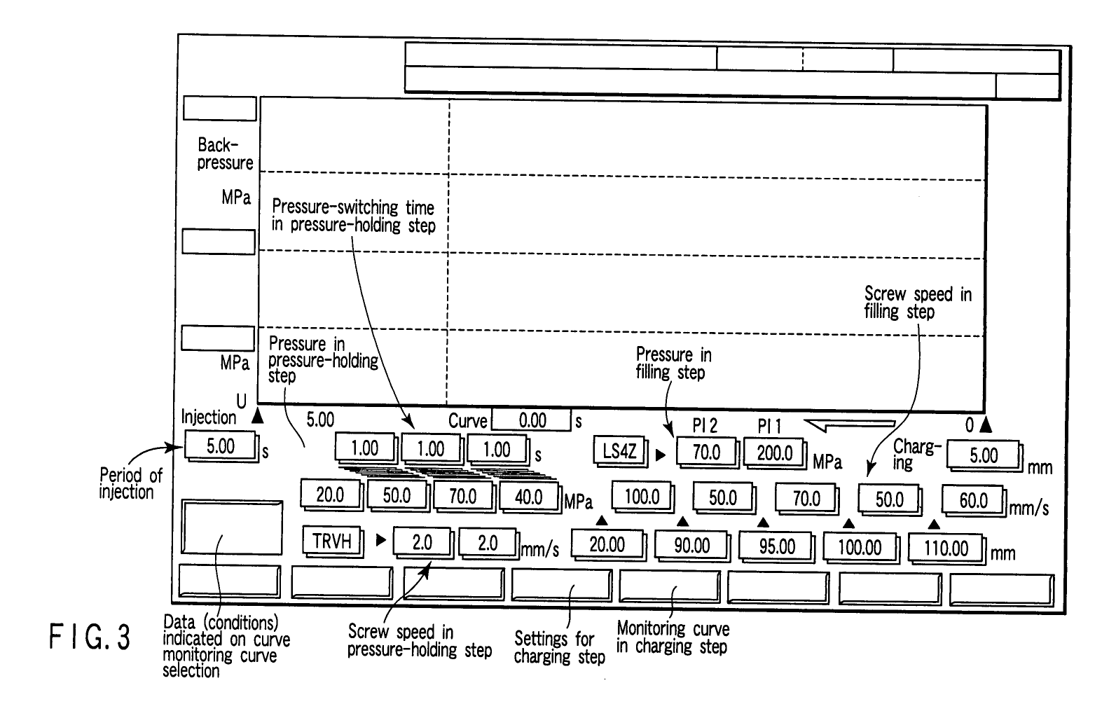

FIG. 3 shows another display screen of the control console used in the injection-molding machine of the present invention. In the upper stage of the display screen, a curve showing the back-pressure of the screw versus time is displayed.

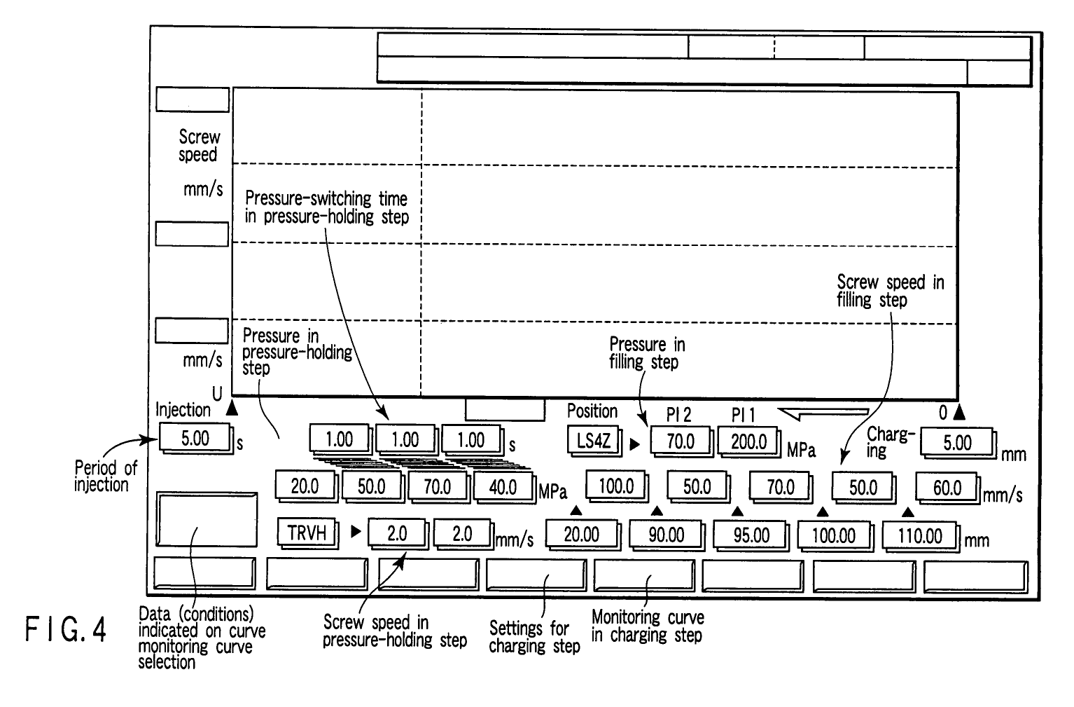

FIG. 4 shows another display screen of the control console used in the injection-molding machine of the present invention. In the upper stage of the display screen, a curve showing forward speed of the screw versus the position of the screw is displayed.

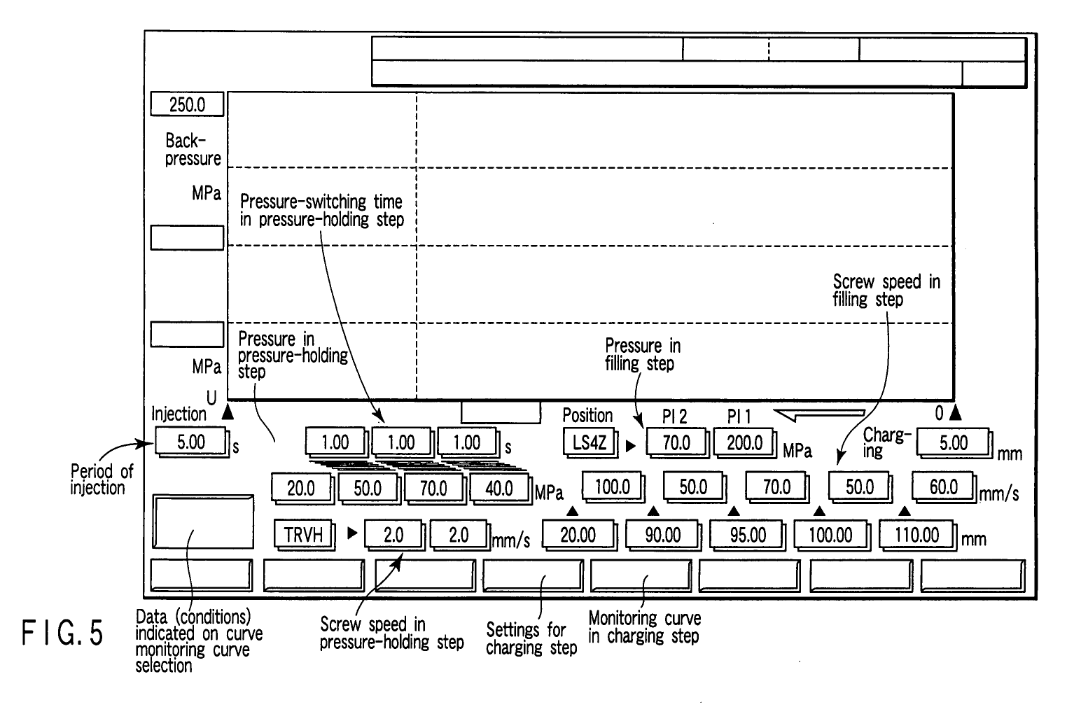

FIG. 5 shows another display screen of the control console used in the injection-molding machine of the present invention. In the upper stage of the display screen, a curve showing the back-pressure of the screw versus the position of the screw is displayed.

According to the injection-molding machine of the present invention, the operator can change settings while monitoring the operation data indicated by the curve displayed on the screen. Therefore, workability for setting the operational conditions can be improved and the setting operation can be accurately performed. As a result, the quality of molded products are improved and the cycle time for injection can be reduced.

What is claimed is:

1. A control console of an injection-molding machine comprising:
a first region displaying a curve showing a position of a screw versus time in filling and pressure-holding steps, and
a second region displaying settings for specifying a forward speed and back-pressure of the screw in the filling and pressure-holding steps,
wherein said first and second regions are arranged on the same display screen such that the settings can be changed while monitoring the curve.

2. The control console according to claim 1, wherein the settings include a screw speed in filling step, pressure in filling step, pressure-switching time in pressure-holding step, screw speed in pressure-holding step, and period of injection.

3. A control console of an injection molding machine, comprising:
a first region displaying a curve showing a forward speed of a screw versus time in filling and pressure-holding steps, and
a second region displaying settings for specifying a forward speed and back-pressure of the screw in the filling and pressure-holding steps,
wherein said first and second regions are arranged on the same display screen such that the settings can be changed while monitoring the curve.

4. The control console according to claim 3, wherein the settings include a screw speed in filling step, pressure in filling step, pressure-switching time in pressure-holding step, screw speed in pressure-holding step, and period of injection.

5. A control console of an injection molding machine, comprising:
a first region displaying a curve showing a back-pressure of a screw versus time in filling and pressure-holding steps, and
a second region displaying settings for specifying a forward speed and back-pressure of the screw in the filling and pressure-holding steps,
wherein said first and second regions are arranged on the same display screen such that the settings can be changed while monitoring the curve.

6. The control console according to claim 5, wherein the settings include a screw speed in filling step, pressure in filling step, pressure-switching time in pressure-holding step, screw speed in pressure-holding step, and period of injection.

7. A control console of an injection molding machine, comprising:
a first region displaying a curve showing a forward speed of a screw versus a position of the screw in filling and pressure-holding steps, and
a second region displaying settings for specifying a forward speed and back-pressure of the screw in the filling and pressure-holding steps,
wherein said first and second regions are arranged on the same display screen such that the settings can be changed while monitoring the curve.

8. The control console according to claim 7, wherein the settings include a screw speed in filling step, pressure in filling step, pressure-switching time in pressure-holding step, screw speed in pressure-holding step, and period of injection.

9. A control console of an injection molding machine, comprising:
a first region displaying a curve showing a back-pressure of a screw versus a position of the screw in filling and pressure-holding steps, and
a second region displaying settings for specifying a forward speed and back-pressure of the screw in the filling and pressure-holding steps,
wherein said first and second regions are arranged on the same display screen such that the settings can be changed while monitoring the curve.

10. The control console according to claim 9, wherein the settings include a screw speed in filling step, pressure in filling step, pressure-switching time in pressure-holding step, screw speed in pressure-holding step, and period of injection.
